(19) United States
(12) Patent Application Publication
(10) Pub. No.: US 2019/0315515 A1
(43) Pub. Date: Oct. 17, 2019

(54) STACKABLE SYSTEM CONTAINER

(71) Applicant: BS Systems GmbH & Co. KG, Zusmarshausen (DE)

(72) Inventors: Reiner GONITIANER, Dillingen (DE); Jan KÖGEL, Zusmarshausen (DE)

(73) Assignee: BS Systems GmbH & Co. KG, Zusmarshausen (DE)

(21) Appl. No.: 16/317,175

(22) PCT Filed: Apr. 11, 2017
(86) PCT No.: PCT/EP2017/058672

§ 371 Date: Jan. 11, 2019

(30) Foreign Application Priority Data
Jul. 13, 2016 (DE) 10 2016 112 853.8

(51) Int. Cl. B65D 21/02; B25H 3/02

(52) U.S. Cl. CPC B65D 21/0217; B25H 3/02

(57) ABSTRACT

A stackable system container includes a base part and a cover part fastened to the base part, and has at least two coupling elements which protrude upward beyond a top side of the system container and which each have at least one recess for the engagement of a coupling device of an identical system container arranged thereabove and which are arranged at opposite ends of the top side of the system container. To permit both dimensionally stable and connected stacking of structurally identical system containers and also modular stacking of different system containers, the coupling elements are fastened pivotably to the top side of the system container such that, in a pivoted-in position, they do not protrude beyond the top side of the system container.

The present invention relates to a stackable system container according to the preamble of claim 1.

DE 10 2013 110 496 discloses a stackable system container comprising a base part having an upward-facing open storage space and a cover part attached to the base part and bounding the storage space at the top. In addition, the system container also comprises two coupling elements that protrude upwardly beyond the top side of the system container and that are integrally formed in one piece with the base part and each comprise at least one latch for engaging the coupling device of an identical container disposed above. The coupling elements are furthermore disposed at oppositely lying ends of the top side of the system container and allow a plurality of such system containers to be centered and positioned one atop the other. After aligning a plurality of system containers with each other, these containers can be connected to each other by means of the coupling elements in a dimensionally stable, but detachable manner. This form- and force-fitting arrangement makes it possible for a plurality of system containers that are connected to each other to be comfortably carried with one hand. The disadvantage of this arrangement, however, is that the coupling elements entail a specific mounting system, thereby making modular use of the system container less feasible when stacking a plurality of different containers.

Thus, the problem to be solved by the present invention is to make available a stackable system container that allows both structurally identical system containers to be stacked in a dimensionally stable and connected arrangement one atop the other and structurally different system containers to be modularly stacked one atop the other.

This problem is solved by a stackable system container having the features of claim 1. Further advanced modifications of the present invention follow from the dependent claims.

The stackable system container according to the present invention is marked by the fact that the coupling elements are movably, especially pivotably, mounted to the top side of the system container in such a way that, in a pivoted-in position, they do not protrude beyond the top side of the system container. Thus, the coupling elements, depending on the specific case, can be pivoted between a pivoted-out and a pivoted-in position. In the protruding pivoted-out position, the coupling elements can interact with each other to retain a system container of the same type that is arranged on top of it, whereas in the pivoted-in position, the coupling elements do not prevent the arrangement of structurally different containers on the system container. Furthermore, in the latter case, the top side of the system container can also be conveniently used as a storage or work space.

In this context, system containers that are structurally identical or of the same type are defined as containers designed to interact with and retain at least two coupling elements of the system container, wherein, with respect to the dimensions or the presence of additional elements, different design layouts are covered as well.

According to a preferred embodiment, the coupling elements, in the pivoted-in position, can form a flat or nearly flat surface with the top side of the system container. This provides the system container with a stepless top side that is especially suitable for use as a storage or work space.

In an especially stable design layout, the coupling elements can preferably be pivoted relative to each other from the protruding position into the pivoted-in position in the direction of the center of the top side of the system container. If, in the protruding pivoted-out position, a structurally identical system container is disposed between the coupling flanges, the coupling elements are locked by the structurally identical system container, thereby preventing these coupling elements from being accidentally moved into the pivoted-in position. It is, however, also possible for the coupling elements to be arranged in such a way that they pivot laterally outwardly or downwardly from the protruding position into the pivoted-in position.

To further increase the stability of the coupling elements, these coupling elements, in the protruding position, can adjoin a stop of the system container. This causes the coupling elements, when in the protruding position, to be retained in a defined position and to be especially effectively shored up against any lateral forces.

The transmission of forces from the coupling elements into the system container can be especially effectively implemented in that the coupling elements in the protruding position engage the stop in the vertical direction from behind. This means that, in the vertical direction, a portion of a coupling element in the protruding position disposed above the stop engages the stop from below. As a result, any vertically upwardly acting forces, such as occur especially when a plurality of stacked system containers are transported, can be especially effectively counteracted. Thus, even relatively heavy system containers, connected to each other, can be transported as a unit by means of the grip on the system container positioned at the top.

To make the top side especially convenient for use as a storage and work space, the top side of the system container can comprise receiving depressions, into which the coupling elements can be pivoted. This result occurs to the greatest extent possible in a closed, stepless surface of the top side, which, in addition, is also easily cleanable.

To ensure positionally stable positioning of the coupling elements in the protruding position and/or the pivoted-in position, each coupling element can have at least one engagement means for the engagement of a coupling element in the upwardly protruding pivoted-out position and/or the pivoted-in position. Preferably, it is possible to override each engagement means by exerting a sufficient torque on the associated coupling element, which can be implemented, for example, by means of a spring-biased detent ball in mating detent grooves.

According to a preferred embodiment, the coupling elements can be attached to a cover part. It is, however, also possible to attach the coupling elements to the side walls of the base part.

To ensure the interlocking retaining connection of two system containers of this type, coupling devices can be disposed on the base part at least on the upper system container, which coupling devices are designed to interact with the coupling elements of the structurally identical system container disposed below. In the vertical direction, a retaining element of a coupling device can be disposed on the system container below a coupling element. If two upwardly protruding coupling elements are disposed at opposite ends of the top side of the system container, an engagement element of a coupling device can be disposed in the vertical direction, one below each of the coupling elements. Each engagement element is designed to interact with and retain coupling elements of a system container disposed below, which coupling elements are structurally identical to the coupling elements of this system container, and more particularly to engage with hook-shaped elements in a recess of the respective coupling element.

In addition, the cover part is preferably pivotably attached to the base part. This provides easy access to the storage space in the base part and, at the same time, an especially stable connection between the cover part and the base part.

Further special features and advantages of the invention follow from the description of preferred practical examples below with reference to the drawings. The drawings show:

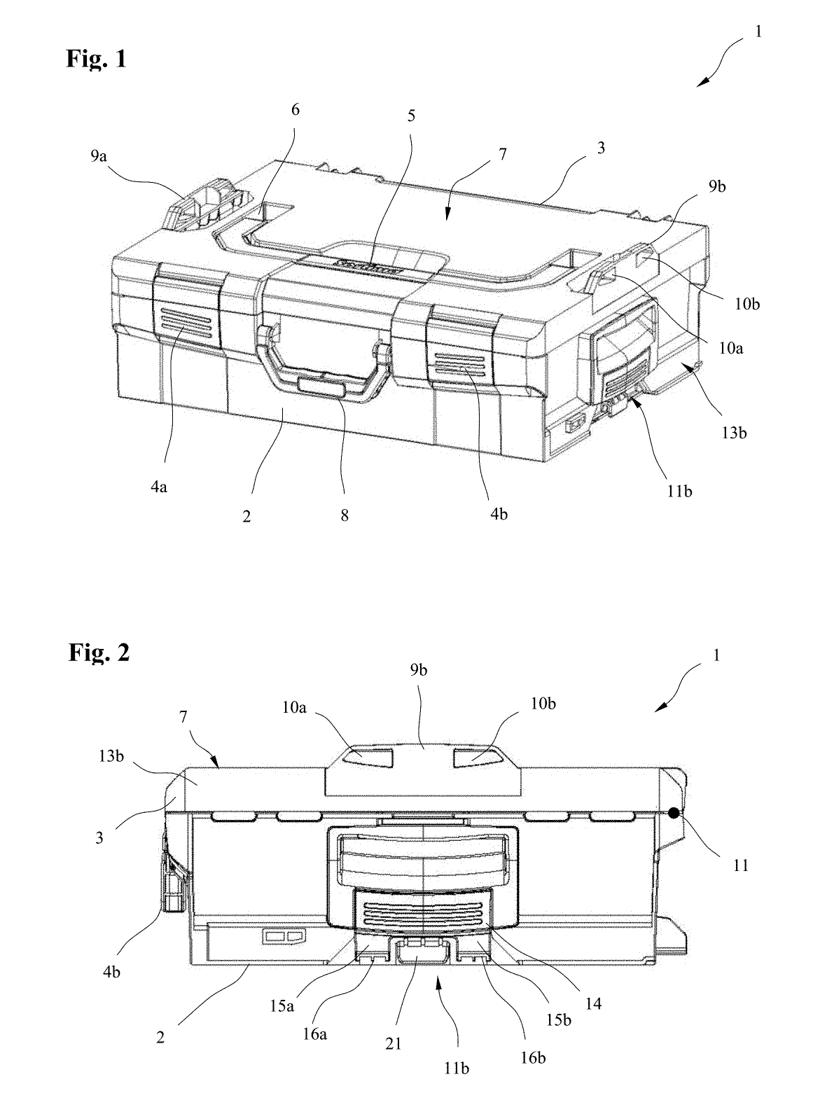

FIG. 1 a perspective representation of a stackable system container comprising upwardly protruding coupling elements;

FIG. 2 a lateral view of the stackable system container of FIG. 1;

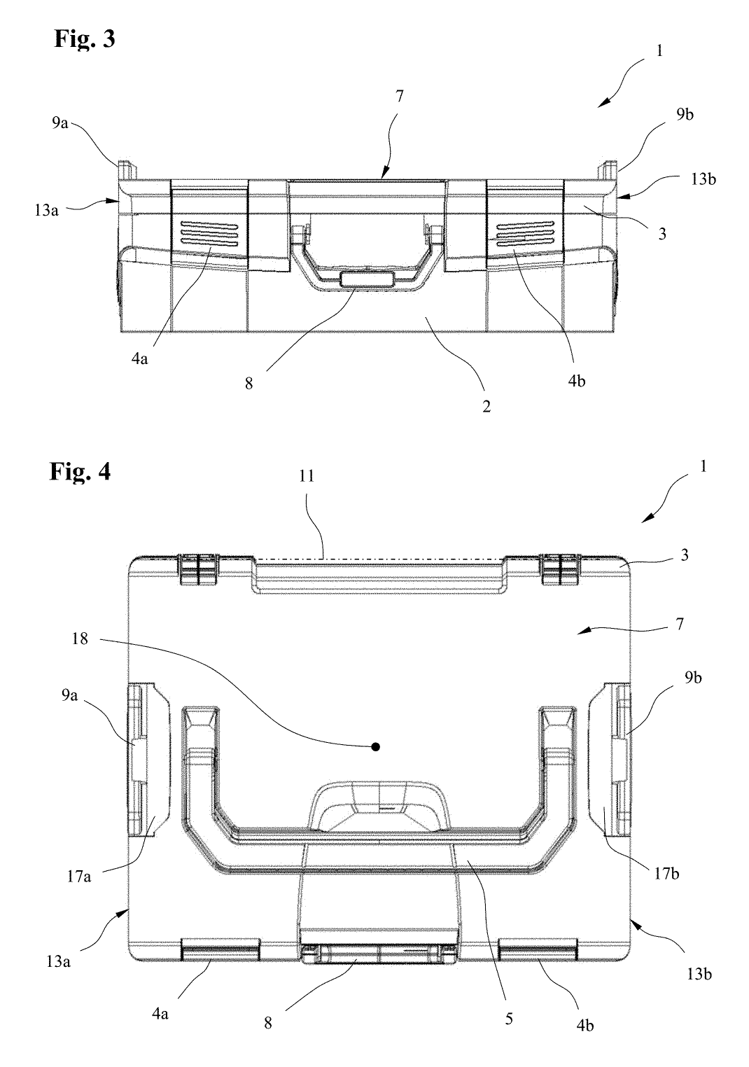

FIG. 3 a front view of the stackable system container of FIG. 1;

FIG. 4 a top view of the stackable system container of FIG. 1;

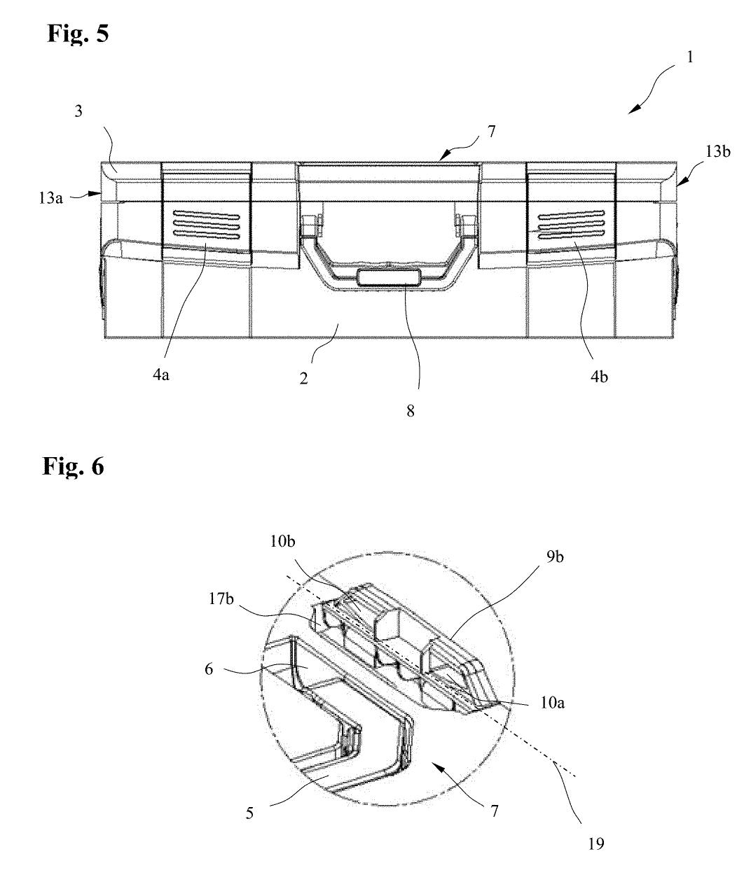

FIG. 5 a front view of a stackable system container with the coupling elements in a pivoted-in position;

FIG. 6 a perspective detail view of a coupling element in the protruding position;

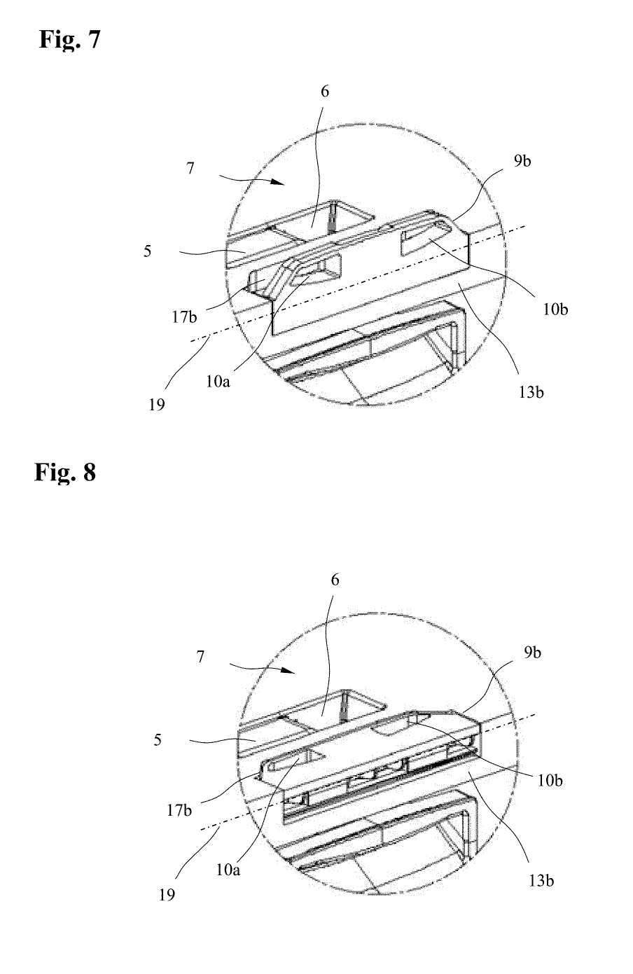

FIG. 7 a second perspective detail view of the coupling element of FIG. 6;

FIG. 8 a perspective detail view of a coupling element in the pivoted-in position;

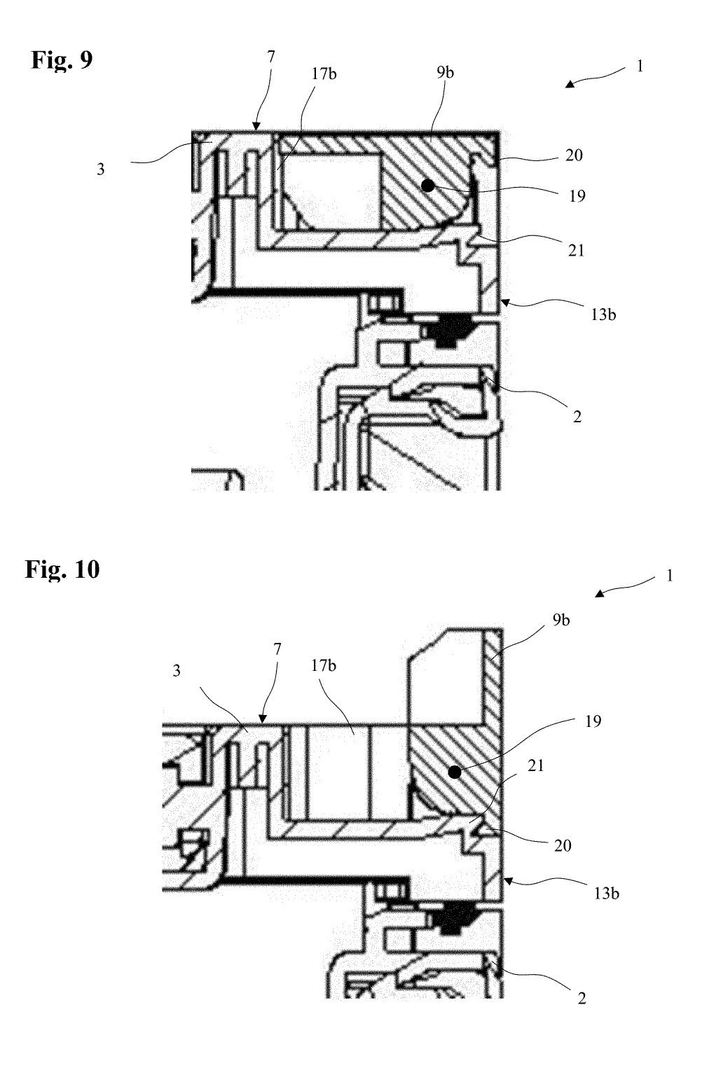

FIG. 9 a sectional view through a system container in the area of a coupling element in the pivoted-in position; and

FIG. 10 a sectional view of a system container in the area of a coupling element in the protruding position.

FIG. 1 shows a perspective representation of a stackable system container 1. The system container 1 comprises a base part 2 and a cover part 3 pivotably attached to the base part 2. The base part 2 has an upward-facing open storage space (not shown) that is bounded on top by the cover part 3. The cover part 3 is pivotably mounted on the base part via a swivel joint disposed on the rearward edge of the cover part. To be able to detachably fasten the cover part 3 to the base part 2 and thereby to securely close the enclosed storage space, two locking means 4a, 4b are provided on the front side of the system container 1, which locking means are hinged to the cover part 3 and, in the closed position of the system container 1 as shown, engagingly interact with the base part 2.

The system container 1 can be used, for example, by craftsmen to transport and store tools and working media. To this end, the base part 2 preferably comprises a bottom section and four side walls that bound an upward-facing open storage space. It is, however, also possible for the base part to be configured like that of the container disclosed in EP 2 703 310. In this context, reference is made to EP 2 703 310, the entire content of which is hereby fully incorporated by reference in the present application.

For easy transport of the system container 1, a retaining bracket 5 is mounted on the cover part 3 so as to be able to pivot between an upwardly protruding position and a pivoted-in position. In the pivoted-in position, the retaining bracket 5 is disposed in such a way that it is recessed in a grip depression 6 of the cover part 3 so that the retaining bracket 5, together with the cover part 3, forms a stepless flat top side 7 of the system container 1. In addition, a handle grip 8 is pivotably attached to a front side of the base part 2, which handle grip allows the system container 1 to be grasped and transported.

The cover part 3 also comprises two coupling elements 9a, 9b in the form of rib-like engaging members that protrude upwardly beyond the top side 7 of the system container 1 and are disposed at opposite ends of the top side 7. The coupling elements 9a, 9b have each two recesses 10a, 10b, which are designed for the engagement of coupling devices of a system container of the same type that is disposed above (not shown). The coupling devices of the system container disposed above (not shown) are designed to be structurally identical to the coupling devices 11a, 11b on the system container 1, the coupling device 11b of which is shown in FIG. 1. The coupling device 11b is disposed on the side of the base part 2 and below the coupling element 9b, and the coupling device 11 a (not shown in FIG. 1) on the oppositely lying side of the base part 2 is similarly disposed below the coupling element 9a.

The recesses 10a, 10b are configured in the form of pockets that extend horizontally through the coupling elements 9a, 9b shown in the drawing and that are designed to be engaged and retained in the vertical direction from behind by the associated coupling device of the system container disposed above (not shown). With regard to the other features of the coupling devices and coupling elements, reference is made to EP 2 703 310, the entire content of which is hereby fully incorporated by reference in the present application.

FIG. 2 shows a lateral view of the stackable system container of FIG. 1. As the lateral view indicates, the base part 2 and the cover part 3 are pivotably connected to each other via the diagrammatically sketched swivel joint 12 and detachably held in place relative to each other by the locking device 4b shown in the drawing.

In the protruding position shown, the coupling element 9b forms a stepless flat lateral surface 13b with the cover part 3, which saves space and provides a visually pleasing appearance. Similarly, the coupling element 9a (not shown in the drawing) on the opposite side forms a flat lateral surface 13a with the cover part 3.

The coupling device 11b comprises a spring-biased retention component 14 that is pivotably attached to a side wall of the base part 2. Disposed on the retention component 14 are two downwardly protruding engagement elements 15a, 15b, each of which has a hook-shaped element 16a, 16b at its lower end. In the vertical direction, the hook-shaped elements 16a, 16b are vertically disposed exactly below the recesses 10a and 10b such that, when two such system containers are stacked one atop the other, the hook-shaped elements 16a, 16b are able to engage in the recesses 10a, 10b of the coupling element disposed below, thereby holding it in place.

By exerting pressure on the retention component 14 and on the oppositely lying unnumbered retention component, which is a mirror image thereof, this retention component can be moved about a horizontal axis from the spring-loaded locked position shown in the drawing into an open position. This causes the hook-shaped elements 16a, 16b to be moved in the horizontal direction and to be disengaged from the recesses 10a, 10b of the coupling element of a second system container disposed below, thereby disconnecting the retaining connection between the system containers. Suitable slanted sliding surfaces on the engagement elements 9a, 9b and/or the hook-shaped elements 16a, 16b make it possible, by simply pushing two system containers against each other, to move the hook-shaped elements 16a, 16b and thus the retention component 14 in the vertical direction, which causes the hook-shaped elements 16a, 16b to automatically engage in the recesses 10a, 10b and the two system containers stacked one atop the other to be automatically connected to each other.

FIG. 3 shows a front view of the stackable system container of FIG. 1. As the drawing indicates, the top side 7 of the system container 1 has a flat stepless surface, on each lateral end of which only the coupling elements 9a, 9b protrude in the position shown. The retaining bracket 5 shown in FIG. 1 is recessed in the grip depression 6 in the top side 7 such that the retaining bracket 5 forms a flat surface with the top side 7.

FIG. 4 shows a top view of the stackable system container 1 of FIG. 1. As the drawing indicates, the top side 7 in the cover part 3 comprises receiving depressions 17a, 17b in which the coupling elements 9a and 9b are disposed. The receiving depressions 17a, 17b are disposed at oppositely lying ends of the top side 7 of the system container 1 and open each one toward one of the lateral surfaces 13a, 13b of the cover part 3. In these receiving depressions 17a, 17b, the coupling elements 9a, 9b are pivotably attached to the top side 7 of the system container 1 in such a manner that they can be pivoted from the protruding position shown in the drawing in the direction of a diagrammatically sketched center 18 of the top side 7 of the system container 1.

To lock the coupling elements 9a, 9b in the pivoted-in position and/or the protruding position, an engagement device known in the art can be disposed between the coupling elements 9a, 9b and the receiving depressions 17a, 17b. This device can be, for example, a spring-biased detent ball in a component, which detent ball is guided in a guide path having engagement pockets at one end or at both ends in the oppositely lying component. Because of the spring bias, it is possible to override the locking means by exerting a sufficient torque on the respective coupling element and to pivot the coupling element from the protruding position into the pivoted-in position.

FIG. 5 shows the system container 1 wherein, in contrast to the preceding figures, the coupling elements 9a, 9b are in the pivoted-in position. In the pivoted-in position, the coupling elements 9a, 9b are completely integrated in the receiving depressions 17a, 17b and in this position do not protrude beyond the top side 7 of the system container 1. The coupling elements are designed to pivotably attach to the cover part 3 in such a manner that, when in the pivoted-in position, they form a flat stepless surface with the top side 7 of the system container 1, which result occurs to the greatest extent possible in a closed surface for the storage of additional system containers of any type as well as in a work space for processing workpieces.

FIG. 6 shows a perspective detail view of the coupling element 9b in the protruding position. The coupling element 9b is designed as a mirror image of the oppositely lying coupling element 9a and is pivotably disposed about the diagrammatically sketched pivot axis 19. Disposed between the recesses 10a, 10b, which extend in the horizontal direction and at right angles to the pivot axis 19, is a positioner receiving means 20 in the form of an upward-facing open pocket that serves to receive a positioning pin 21 as shown in FIG. 2, which positioning pin is rigidly disposed on the base part 2. The positioning pin 21 and the positioner receiving means 20 facilitate the easy positioning of and connection between two system containers 1 of the same type that are disposed one atop the other.

As FIG. 6 indicates, the horizontal contour of the receiving depression 17b as well as that of the receiving depression 17a, which is configured as a mirror image thereof, is designed to correspond to the vertical contour of the coupling element 9b in the protruding position shown in the drawing. The effect of this is that the coupling elements 9a, 9b in the pivoted-in position close the receiving depressions 17a, 17b to the greatest extent possible free from gaps in order to prevent working materials or dirt from penetrating when the top side 7 is used as a work space.

FIG. 7 shows a second perspective detail view of the coupling element 9b of FIG. 6. As the drawing indicates, the coupling element 9b as well as the complementarily shaped oppositely lying coupling element 9a is disposed in the receiving depression 17b in such a way that this coupling element, in the protruding position shown in the drawing, is flush with the lateral surface 13b of the cover part 3. The pivot axis 19 is oriented parallel relative to the top side 7 and the lateral surface 13b.

FIG. 8 shows a perspective detail view of the coupling element 9b in the pivoted-in position in which the coupling element 9b is flush with the top side 7 of the system container 1. As can also be seen, in this position, the coupling element 9b upwardly closes the receiving depression 17b to the greatest extent possible free from gaps. In addition, the coupling element 9b here is designed to be flush with the lateral surface 13b of the cover part 3, but in contrast to the configuration shown in the drawing, the coupling element 9b can also laterally close the receiving depression 17b to the greatest extent possible free from gaps with respect to the lateral surface 13b.

FIG. 9 shows a cross-section through a system container 1 in the area of the coupling element 9b. The coupling element 9b here is in the pivoted-in position and closes the receiving depression 17b upwardly flush with the top side 7 of the system container 1. In addition, the coupling element 9b is also flush with the lateral surface 13b and especially laterally does not protrude beyond that surface. Provided on the coupling element 9b at a distance from the pivot axis 19 is a projecting part 22 that is designed to correspond to a stop 23 disposed in the receiving depression 17b. The projecting part 22 has a wedge-shaped cross-section, and the stop 23 has a matching wedge-shaped groove. It is, however, also possible to dispose the stop 23 for the projecting part 22 on the cover part 3 outside the receiving depression 17b and/or to configure it differently. In addition, by providing suitable pressure points or recesses for fingers, it is possible to facilitate the swiveling in and out of the coupling elements 9a, 9b.

FIG. 10 shows a cross-section through the system container 1 of FIG. 9, wherein the coupling element 9b is in a position pivoted by 90° and protruding vertically upwardly beyond the top side 7. As the drawing indicates, the projecting part 22 sits close to the stop 23 and, in addition, engages the stop from behind. In a variation of the wedge-shaped groove shown in the drawing, the stop 23 can also have a rectangular cross-section that is engaged from behind by a corresponding projecting part 22. Because the coupling element 9b disposed above the stop 23 engages the stop 23 with the projecting part 22 in the vertical direction from below, vertical tensile forces on the coupling element 9b can be introduced to special advantage into the cover part 3.

Because the arrangement and design of the coupling elements 9a, 9b mirror the arrangement and design of the receiving depressions 17a, 17b, the configuration described with reference to the figures for one side also applies to the oppositely lying coupling element having the receiving depression associated therewith. Similarly, the coupling devices 11a, 11b on the base part 2 are also designed as mirror images of each other so that reference is again made to the configuration described.

In a variation of the configuration shown in the drawing, it is also possible to attach the coupling elements 9a, 9b to oppositely lying side walls of the base part 2. The receiving depressions 17a, 17b can again be completely integrated in the side walls or extend at least partially within the cover part 3.

### LIST OF REFERENCE CHARACTERS

1 Stackable system container
2 Base part
3 Cover part
4a, 4b Locking device
5 Retaining bracket
6 Grip depression
7 Top side of the system container
8 Handle grip
9a, 9b Coupling element
10a, 10b Recess
11a, 11b Coupling device
12 Swivel joint
13a, 13b Lateral surface
14 Retention component
15a, 15b Engagement element
16a, 16b Hook-shaped element
17a, 17b Receiving depression
18 Center of the top side
19 Pivot axis
20 Positioner receiving means
21 Positioning pin
22 Projecting part
23 Stop

1. A stackable system container comprising a base part and a cover part fastened to the base part, and having at least two coupling elements that protrude upwardly beyond a top side of the system container and that each have at least one recess for engagement of a coupling device of an identical system container disposed above and that are disposed at oppositely lying ends of the top side of the system container, wherein the coupling elements are pivotably attached to the top side of the system container in such a manner that, in a pivoted-in position, the coupling elements do not protrude beyond the top side of the system container.

2. The system container of claim 1, wherein the coupling elements, in the pivoted-in position, form a flat surface with the top side of the system container.

3. The system container of claim 1, wherein the coupling elements can be pivoted from the protruding position into the pivoted-in position in the direction of the center of the top side of the system container.

4. The system container of claim 1, wherein the coupling elements, in the protruding position, sit close to a stop of the system container.

5. The system container of claim 4, wherein the coupling elements, in the protruding position, engage the stop in the vertical direction from behind.

6. The system container of claim 1, wherein the receiving depressions are disposed on the top side of the system container, into which receiving depressions the coupling elements can be pivoted.

7. The system container of claim 1, wherein, for each coupling element, at least one engagement means for the engagement of the coupling element in the upwardly protruding position and/or in the pivoted-in position is provided.

8. The system container of claim 7, wherein each engagement means can be overridden by exerting a sufficient torque on the respective coupling element.

9. The system container of claim 1, wherein the coupling elements are attached to a pivotable cover part.

10. The system container of claim 1, wherein the coupling elements are disposed on the side walls of the base part.

11. The system container of claim 1, wherein coupling devices are disposed on the base part, which coupling devices are designed to interact with the coupling elements of a structurally identical system container disposed below.

12. The system container of claim 1, wherein, in the vertical direction, each engagement element of a coupling device is disposed below a coupling element.

13. The system container of claim 12, wherein the engagement elements of the coupling devices can be moved between a locked position and an open position.

14. The system container of claim 1, wherein the cover part is pivotably attached to the base part.
